(19) United States
(12) Patent Application Publication
(10) Pub. No.: US 2010/0296304 A1
(43) Pub. Date: Nov. 25, 2010

(54) COMBINATION FOR A VEHICLE INCLUDING A SELF-CONTAINED LIGHT

(76) Inventors: MARC HAYES, Plymouth, MI (US); JAMES J. HOBSON, Hanover, MI (US); MICHAEL W. CASS, Lenox, MI (US)

Correspondence Address: INTERNATIONAL AUTOMOTIVE COMPONENTS GROUP, LLC;c/o MACMILLAN, SOBANSKI & TODD, LLC, ONE MARITIME PLAZA, FIFTH FLOOR, 720 WATER STREET, TOLEDO, OH, 43604, US

(21) Appl. No.: 12/468,089

(22) Filed: May 19, 2009

(51) Int. Cl. B60Q 3/06

(52) U.S. Cl. 362/488; 362/543

(57) ABSTRACT

A combination for a vehicle is set forth herein. The combination includes a compartment positioned in the vehicle. The compartment is defined by a plurality of surfaces generally facing one another to define an interior volume. The compartment is thereby operable to hold a stowable item. A first surface of the plurality of surfaces is substantially fixed relative to the vehicle and a second surface of the plurality of surfaces is movable relative to the first surface. The combination also includes at least one self-contained light mounted on the second surface. The at least one self-contained light includes at least one light emitting structure and at least one battery.

### BACKGROUND OF THE INVENTION

1. Field of the Invention

The invention relates to vehicle lighting and more specifically for a combination including a light for a vehicle.

2. Description of Related Prior Art

U.S. Pat. No 4,202,030 discloses a multi-purpose illumination device provided in a floor mounted console in a motor vehicle. The illumination device includes a lamp, a portable source of power such as a battery for the lamp, and a box cover coupled to the console through a hinge. The illumination device illuminates an instrument panel of the motor vehicle and the cover prevents the illumination device from casting light onto a windshield of the motor vehicle.

### SUMMARY OF THE INVENTION

In summary, the invention is a combination for a vehicle. The combination includes a compartment positioned in the vehicle. The compartment is defined by a plurality of surfaces generally facing one another to define an interior volume. The compartment is thereby operable to hold a stowable item. A first surface of the plurality of surfaces is substantially fixed relative to the vehicle and a second surface of the plurality of surfaces is movable relative to the first surface. The combination also includes at least one self-contained light mounted on the second surface. The at least one self-contained light includes at least one light emitting structure and at least one battery.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a perspective view of a self-contained first exemplary light operable to be used in a combination according to an embodiment of the invention;

FIG. 2 is a cross-section taken along section lines 2-2 in FIG. 1;

FIG. 3 is a cross-section taken along section lines 3-3 in FIG. 1;

FIG. 4 is a cross-section analogous to the cross-section in FIG. 2 but of a second exemplary self-contained light operable to be used in a combination according to an embodiment of the invention;

FIG. 5 is a perspective view of a first exemplary embodiment of the invention;

FIG. 6 is a perspective view of a second exemplary embodiment of the invention;

FIG. 7 is a first schematic view of a switch associated with the second exemplary embodiment of the invention;

FIG. 8 is a second schematic view of a switch associated with the second exemplary embodiment of the invention;

FIG. 9 is a perspective view of a third exemplary embodiment of the invention;

FIG. 10 is a cross-section similar to the cross-section in FIG. 4 and also shows two differently constructed mounting surfaces;

FIG. 11 is a schematic of a first exemplary regulator circuit operable to be used in a combination according to an embodiment of the invention;

FIG. 12 is a schematic of a second exemplary regulator circuit operable to be used in a combination according to an embodiment of the invention;

FIG. 13 is a schematic of a third exemplary regulator circuit operable to be used in a combination according to an embodiment of the invention; and

FIG. 14 is a simplified flow diagram illustrating an exemplary method for regulating voltage across a light emitting diode according to an embodiment of the invention.

### DETAILED DESCRIPTION OF THE EXEMPLARY EMBODIMENT

A plurality of different embodiments of the invention is shown in the Figures of the application. Similar features are shown in the various embodiments of the invention. Similar features have been numbered with a common reference numeral and have been differentiated by an alphabetic suffix. Also, to enhance consistency, the structures in any particular drawing share the same alphabetic suffix even if a particular feature is shown in less than all embodiments. Similar features are structured similarly, operate similarly, and/or have the same function unless otherwise indicated by the drawings or this specification. Furthermore, particular features of one embodiment can replace corresponding features in another embodiment or can supplement other embodiments unless otherwise indicated by the drawings or this specification.

The exemplary embodiments set forth herein, as well as other embodiments of the broader invention, can be practiced in vehicles for land, sea or air.

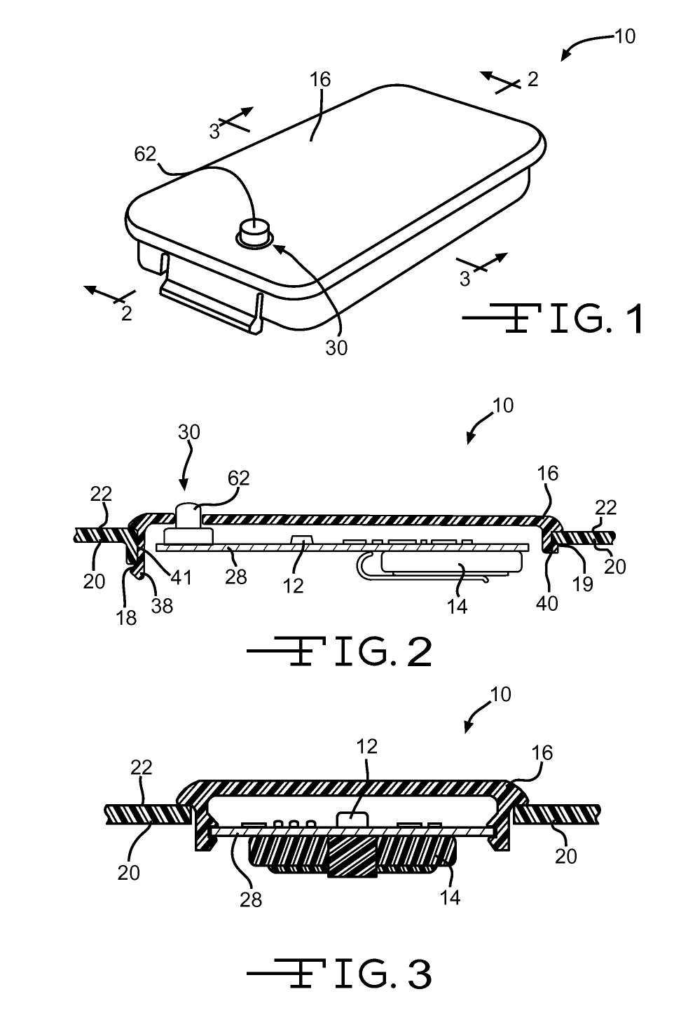

FIGS. 1-3 show a first exemplary self-contained light 10 according to an embodiment of the invention. The light 10 is self-contained in that it includes a light emitting structure and a source of power to illuminate the light emitting structure. In the exemplary embodiment, the self-contained light 10 includes a light emitting diode 12 (hereafter LED) as the light emitting structure, however other light emitting structures can be used in alternative embodiments of the invention such as incandescent or electro-luminescent light sources. The exemplary self-contained light 10 can also include a battery 14 to provide power to the LED 12. The battery 14 can be in any form of battery known in the art. In alternative embodiments of the invention, the self-contained light can include a plurality of light emitting structures and/or a plurality of power sources. The plurality of light emitting structures and/or a plurality of power sources can be arranged in series or in parallel.

The exemplary self-contained light 10 can also include a lens 16 of clear or opaque material. The lens 16 can be formed with one or more projections or recesses to engage other structures. For example, the lens 16 can include one or more outwardly facing notches 18, 19 to engage other structures, such as a structure 20 in a vehicle. The notches 18, 19 are defined by projections 38, 40 that can be individually or collectively deflected during insertion of the lens 16 into an aperture 41 defined in the surface 22. The cooperation between the notches 18, 19 and the structure 20 can fix self-contained light 10 to the structure 20. As will be described in greater detail below, the structure 20 can define a surface 22 of a compartment in a vehicle. As shown by FIGS. 2 and 3, such engaging structures like the notches 18 and 19 can be discontinuous.

In another example, the lens 16 can also include one or more inwardly facing notches 24, 26 to engage other structures, such as a circuit board 28 of the self-contained light 10. A plurality of components can be mounted on the circuit board 28 to control the power delivered to the LED 12 by the battery 14. These components can include a switch, such as switch 30. Examples of various circuits that can be applied in practicing embodiments of the invention will be set forth in greater detail below.

It is noted that while the exemplary self-contained light 10 appears rectangular, the invention is not limited to that shape. Embodiments of the invention can be practiced with self-contained lights of any shape and/or combinations of differently-shaped lights.

FIG. 4 is a cross-section analogous to the cross-section in FIG. 2 but of a second exemplary self-contained light 10a operable to be used in a combination according to an embodiment of the invention. The self-contained light 10a can include an LED 12a, a battery 14a, a lens 16a, a circuit board 28a, and a switch 30a. The second exemplary self-contained light 10a can also include a housing member 32a. The housing member 32a can include inwardly facing grooves 34a, 36a that can receive projections 38a, 40a, respectively, formed by the lens 16a. The cooperation between the notches 34a, 36a and the projections 38a, 40a, respectively, can fix the lens 16a to the housing member 32a. The housing member 32a can include one or more projections 42a, 44a for engaging a structure 20a in a snap-fit arrangement. The cooperation between the projections 42a, 44a and the structure 20a can fix the self-contained light 10a to the structure 20a. The projections 42a, 44a that can be individually or collectively deflected during insertion of the housing member 32a into an aperture 41a defined in the surface 22a. As will be described in greater detail below, the structure 20a can define a surface 22a of a compartment in a vehicle.

A comparison of FIGS. 1-3 and 4 reveals that various self-contained lights operable for practicing the invention can have different mounting structures or mounting architecture. In a single vehicle, all of the self-contained lights can include the mounting structure shown in FIGS. 1-3 (direction connection of the lens to the structure in the vehicle) or the mounting structure shown in FIG. 4 (an intermediate housing member between the lens and the structure in the vehicle). Alternatively, a single vehicle can include some self-contained lights having the mounting structure shown in FIGS. 1-3 and some having the mounting structure shown in FIG. 4. Alternatively, a single vehicle can include self-contained lights having mounting structures different than the mounting structures shown in the exemplary embodiments of the invention.

FIG. 5 is a perspective view of a first exemplary embodiment of the invention. FIG. 5 shows an interior 46 of a vehicle. A compartment 48 is positioned in the vehicle. In the first exemplary embodiment of the invention, the compartment 48 can be a glove compartment accessible through an instrument panel 50. The compartment 48 is defined by a plurality of surfaces generally facing one another to define an interior volume such that the compartment 48 is operable to hold a stowable item. A first surface of the plurality of surfaces is substantially fixed relative to the vehicle. A second surface of the plurality of surfaces is movable relative to the first surface. In the first exemplary embodiment of the vehicle, the first surface could be defined by a driver-side wall 52, a passenger-side wall (not visible), a back wall 54, or a top wall 56 of the glove compartment 48. The second surface 58 is the inwardly facing surface of a door 60 of the glove compartment 48. The door 60 can be connected relative to the instrument panel 50 through a hinge. The self-contained light 10 can be mounted on the second surface 58.

As shown in FIGS. 1 and 2, the switch 30 of the self-contained light 10 can be a plunger-type switch. A plunger 62 of the switch can be spring-biased to partially extend outside of the self-contained light 10 when the door 60 is in the open position shown in FIG. 5. When the plunger 62 is in this position, current can flow to the LED 12 from the battery 14 causing illumination. When the door 60 is in a closed position, the plunger 62 can be forced inward relative to the lens 16 causing the flow of current to the LED 12 to cease.

It is noted that the self-contained light 10 can include a structure for focusing light in a desired direction. For example, the lens 16 can be integrally formed with some form of light-focusing portion. Alternatively, the self-contained light 10 can include a light-deflecting structure positioned adjacent to the lens to deflect illumination from the LED 12 in a desired direction.

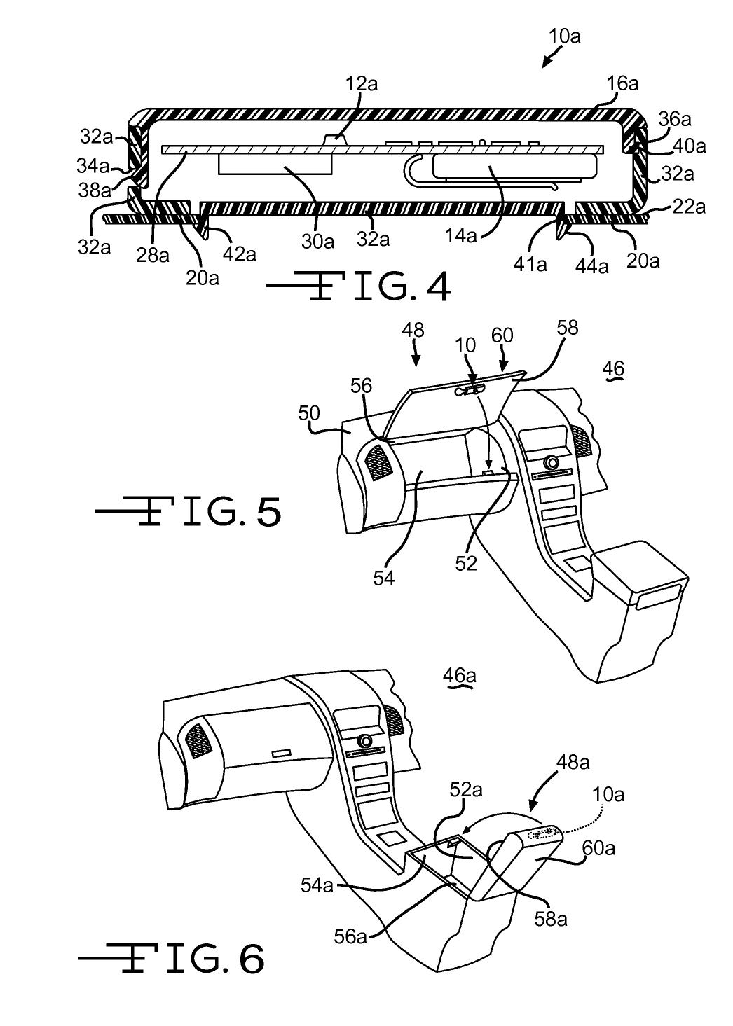

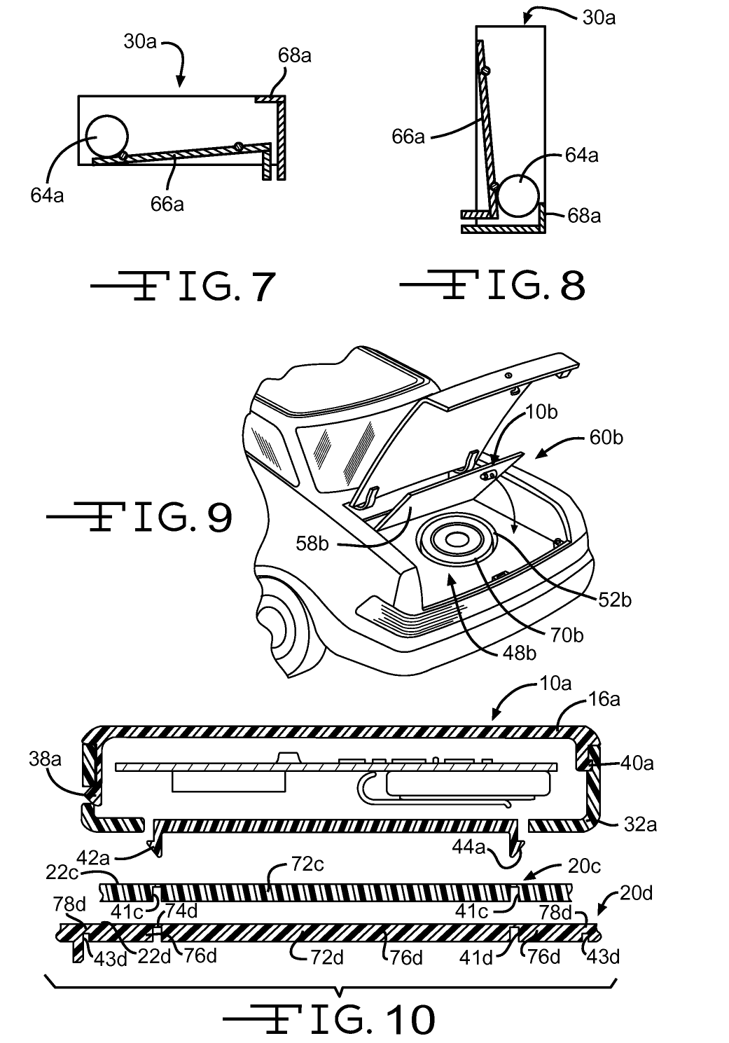

FIG. 6 is a perspective view of a second exemplary embodiment of the invention. FIG. 6 shows an interior 46a of a vehicle. A compartment 48a is positioned in the vehicle. In the second exemplary embodiment of the invention, the compartment 48a can be defined in a center console of the vehicle, between two front seats or between two rear seats. Such a compartment can also be defined in an armrest that can be pivoted between an “in use” position resting on a seat cushion between two seats (front or rear) and a “stowed” position wherein a bottom surface of the armrest is flush with the seat backs.

The compartment 48a is defined by a plurality of surfaces generally facing one another to define an interior volume such that the compartment 48a is operable to hold a stowable item. A first surface of the plurality of surfaces is substantially fixed relative to the vehicle. A second surface of the plurality of surfaces is movable relative to the first surface. In the second exemplary embodiment of the vehicle, the first surface could be defined by a driver-side wall 52a, a passenger-side wall (not visible), a front wall 54a, or a bottom wall 56a of the console compartment 48a. In an armrest embodiment, the first surface could be defined by part of the hinge structure that permits movement of the armrest, but is fixed to the vehicle. For example, a portion of the hinge structure would be exposed in the armrest compartment and thereby define a first surface.

The second surface 58a can be the inwardly facing surface of a box-lid 60a of the console compartment 48a. A self-contained light 10a can be mounted on the second surface 58a. As shown in FIG. 4, the switch 30a of the self-contained light 10 can be fully internal to the self-contained light 10a. FIGS. 7 and 8 show the switch 30a in two different orientations. FIG. 7 shows the switch 30a in an open configuration wherein the flow of current from the battery 14a (shown in FIG. 4) to the LED 12a (shown in FIG. 4) is prevented. The flow of current can be prevented because a bridging member 64a of the switch 30a is isolated from one of two contacts 66a, 68a of the switch 30a. The switch 30a can be in this orientation when the box-lid 60a (shown in FIG. 6) is in the closed position. When the box-lid 60a is opened, the bridging member 64a can moved to bridge the two contacts 66a, 68a, as shown in FIG. 8. When the switch 30a is in the orientation shown in FIG. 8, current can flow from the battery 14a (shown in FIG. 4) to the LED 12a (shown in FIG. 4).

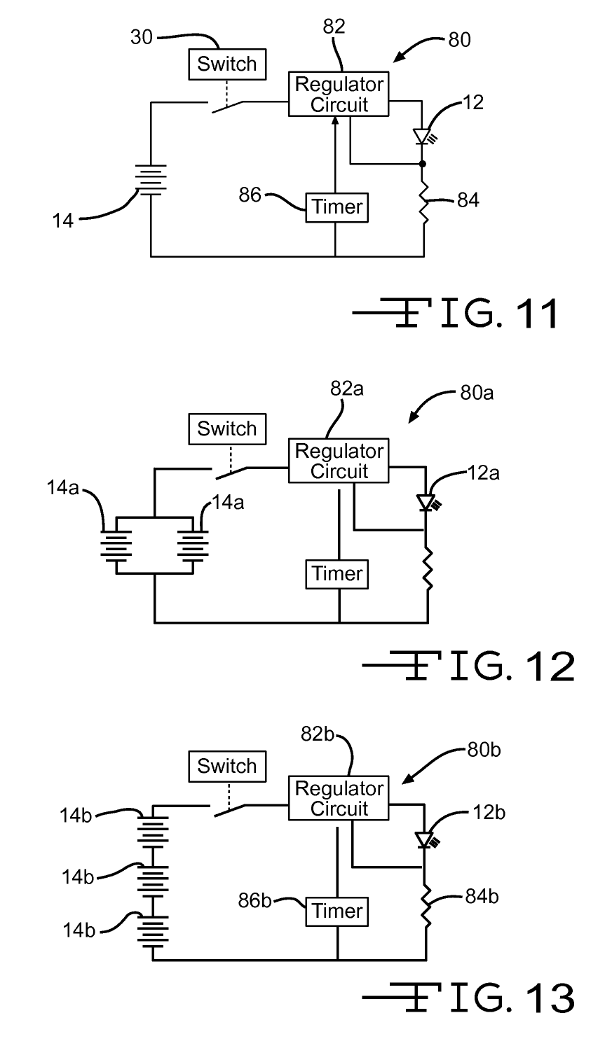

FIG. 9 is a perspective view of a third exemplary embodiment of the invention. FIG. 9 shows a rear end of a vehicle. A compartment 48b is positioned in the vehicle. In the third exemplary embodiment of the invention, the compartment 48b can be defined in a trunk of the vehicle. The compartment 48b is defined by a plurality of surfaces generally facing one another to define an interior volume such that the compartment 48b is operable to hold a stowable item. A first surface of the plurality of surfaces is substantially fixed relative to the vehicle. A second surface of the plurality of surfaces is movable relative to the first surface. In the third exemplary embodiment of the vehicle, the first surface could be defined by well 52b shaped to receive an item such as a spare tire 70b, a jack (not shown) to raise the vehicle, or any other item. The second surface 58b can be the bottom surface 58b of a cargo floor 60b positioned in the trunk. The self-contained light 10b can be mounted on the second surface 58b with adhesive or with snap-fit connections or any other attachment arrangement. The self-contained light 10b can include a plunger switch such as switch 30a or a tilt switch such as switch 30b or some other kind of switch. A reed switch can also be used, wherein a magnet would be positioned on a mating surface of self-contained light. The self-contained light 10b can illuminate when the cargo floor 60b is lifted to access the compartment 48b.

Embodiments of the invention can be practiced wherein a plurality of self-contained lights are positioned in various compartments in the vehicle. The compartments described above; other compartments can receive a self-contained light such as a door panel map pocket. One or more self-contained lights can be positioned in each compartment. The self-contained lights can have a common mounting structure or can have different mounting structures. The self-contained lights can be similarly shaped or can be differently shaped. Each self-contained light can include a switch operating independently of one another.

The exemplary lights described above can be added as options to vehicles. The exemplary lights are self-contained and so can be added without wiring or modifying the vehicle's control programming. Vehicles can be manufactured such that self-contained lights can be included or omitted without creating specialized mounting locations for the self-contained lights. A common mounting structure in the second surface can be relatively unapparent.

For example, the structure defining the second surface can be included in two different models of the same vehicle or in two different vehicles, wherein the two different models or the two different vehicles are differentiated by price and or standard options. A self-contained light can be mounted in the structure in first vehicle model and omitted in a second vehicle model. The self-contained light can include one or more projections for engaging one or more apertures in the second surface. The second surface can be constructed such that the one or more apertures are initially closed with removable covers.

FIG. 10 shows an example of removable covers. In FIG. 10, the light 10a is shown having projections 42a and 44a for a snap-fit connection. FIG. 10 also shows two possible structures 20c and 20d that respectively form second surfaces 22c and 22d. The respective second surfaces 22c and 22d can at least partially define a compartment in a vehicle. The structure 20c defines an aperture 41c that is covered by removable cover 72c. The removable cover 72c can be connected to the remainder of the structure 20c through one more webs 74c. The one or more webs 74c can be punctured when the projections 42a and 44a are pressed into the aperture 41c, causing the removable cover 72c to be separated from the structure 20c.

However, if the vehicle is not to receive a self-contained light, the webs 74c will not be punctured and the surface 22c can be continuous. Thus, the structure 20c can be used in a vehicle that is to receive a self-contained light and also in a vehicle that is not to receive a self-contained light, without defining a visible aperture in the vehicle that is not to receive a self-contained light.

FIG. 10 also shows the structure 20d having a plurality of removable covers 72d and 76d. The cover 72d can be a sub portion of the cover 76d. The cover 72d can be removed to accept the projections 42a and 44a into the aperture 41c. The structure 20d can include the cover 76d to create a common structure for (1) omitting a self-contained light without defining a visible aperture, (2) mounting the self-contained light 10a to the surface 22d by inserting the projections 42a, 44a of the housing member 32a into an aperture 41d of the structure 20d, or (3) mounting the self-contained light 10a to the surface 22d by inserting the projections 38a, 40a of the lens 16a into an aperture 43d of the structure 20d. The aperture 41d can be covered by the removable cover 72d until one or more webs 74d are punctured. The aperture 41d can be covered by the removable cover 72d until one or more webs 74d are punctured. The aperture 43d can be covered by the removable cover 76d until one or more webs 78d are punctured. The one or more webs 78d can be thicker than the one or more webs 76d to prevent the one or more webs 78d from tearing during insertion of the projections 42a, 44a into the aperture 41d.

FIG. 11 is a schematic of an exemplary embodiment of a circuit 80 that can be applied in self-contained lights used to practice the invention. The circuit 80 can include the LED 12, the switch 30, the battery 14, a regulator circuit 82, a resistor 84, and a timer 86. In general, the battery 14 may provide up to three volts for powering the LED 12. The LED 12 may require a supply voltage within a predefined voltage range of 3.0 to 3.5 volts to illuminate. To compensate for the possible 0.5 voltage shortfall from what the battery 14 may be capable of providing, the regulator circuit 82 may increase the amount of voltage provided to the LED 12. In one example, the regulator circuit 82 may be the ZXSC400 boost circuit as produced by Zetex Semiconductors®.

In operation, when the switch 30 is closed, the battery 14 can provide voltage to power the regulator circuit 82. The regulator circuit 82 generally requires an input voltage of between one and eight volts. The regulator circuit 82 can provide an output voltage for powering the LED 12 in response to the voltage provided by the battery 14. The resistor 84 is positioned in series with the LED 12. The regulator circuit 82 measures voltage across the resistor 84 and uses such a measured voltage as feedback for determining whether the LED 12 is receiving a voltage within the predefined voltage range of between 3.0 to 3.5 volts.

For example, the regulator circuit 82 generally includes a predetermined voltage value stored therein that corresponds to a predetermined voltage drop across the resistor 84. The predetermined voltage drop across the resistor 84 is indicative of the amount of current flowing through the LED 12. In one example, the predetermined voltage value may correspond to a value of approximately 0.3 volts. The predetermined voltage value may vary accordingly based on the size of the resistor and on the particular current requirements of the LED 12 that is needed to allow the LED 12 to illuminate as desired. The regulator circuit 82 compares the measured voltage across the resistor 84 to the predetermined voltage value to determine the amount of current to provide to the LED 12.

The regulator circuit 82 is generally configured to provide the same amount or more voltage than that is capable of being provided by the battery 14. The regulator circuit 82 is generally configured to hold the current constant across the LED 12 by continually monitoring and comparing the voltage across the resistor 84 to the predetermined voltage value and adjusting the voltage output in response thereto. While not shown, it is generally contemplated that additional LEDs may be added to the circuit 80 so that such additional LEDs may receive the same voltage output from the regulator circuit 80. By ensuring that the LED 12 and any additional LEDs positioned within the self-contained light receives a constant current, the LED 12 and the additional LEDs (not shown) may provide a similar light output from one another through all voltage variations.

The timer 86 is operable to change the switch 30 from the closed configuration to an open configuration after a predetermined period of time has passed. The operation of the timer 86 enhances battery life by limiting usage that is not required, such as when an occupant of the vehicle forgets to close a compartment. Not all of the self-contained lights in a vehicle need include a timer. The timer 86 is generally enabled to begin a count sequence in response to the switch 30 being closed. The timer 86 may be set to open the circuit 80 upon achieving a predetermined count value. In one example, the predetermined count value may correspond to 90 seconds. The length of the predetermined count value may affect the life of the battery 14. As such, a larger predetermined count value may adversely impact the life span of the battery 14. In most cases, automotive Original Equipment Manufactures (OEMs) may require that the life span of the battery 14 achieve a ten year life span. Due to such a requirement, it is generally contemplated that the predetermined count value may correspond to a value between 30 to 240 seconds. The timer 86 may be implemented as Part Number MC14541B as produced by ON Semiconductor®. In response to the timer 86 achieving the predetermined count value, the timer 86 may transmit a control signal to the regulator circuit 82 so that the regulator circuit 82 may discontinue providing voltage to the LED 12.

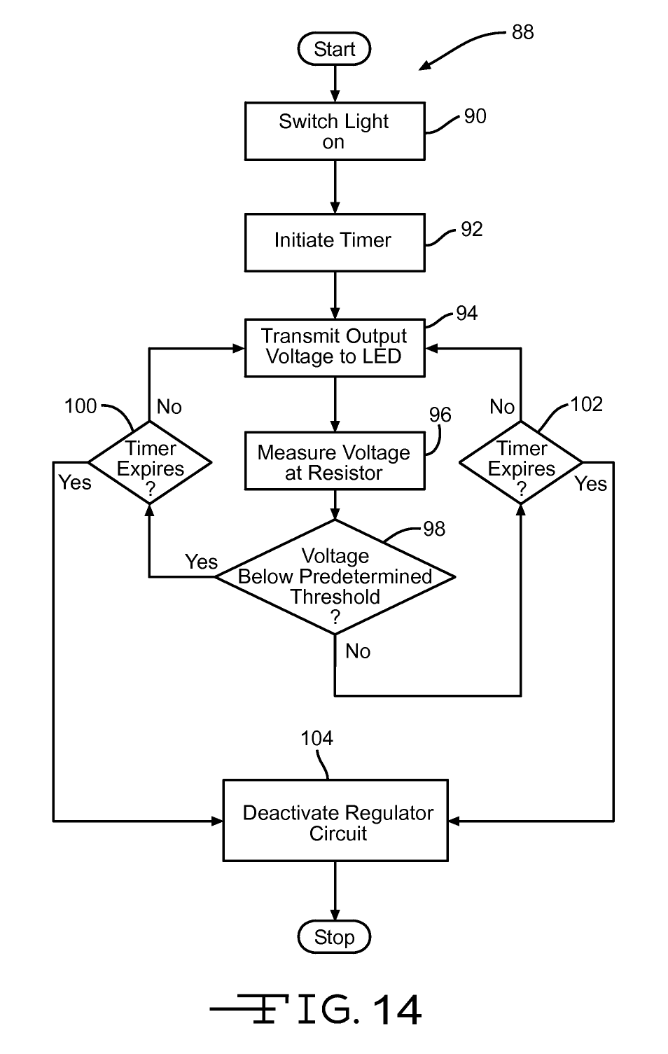

FIG. 12 is a schematic of an example alternative circuit 80a. Circuit 80a includes a plurality of batteries 14a coupled in a parallel configuration. Multiple batteries 14a may be implemented in order to achieve the OEM desired life span. For example, the batteries 14 as shown in FIG. 11 may provide 1100 mAh. The plurality of batteries 14a as depicted in FIG. 12 may provide for 2220 mAh and a total voltage output of 3.0 volts. In such a case, the regulator circuit 82a may increase the amount of voltage that is provided by the plurality of batteries 14a to provide the desired amount of voltage to the LED 12a.

FIG. 13 is a schematic of an example alternative circuit 80b. Circuit 80b resembles circuit 80a in FIG. 12 with the exception of the plurality of batteries 14b being shown in a series configuration. Such a battery arrangement may also achieve the OEM desired life span. Each of the batteries 14b may provide up to 1.5 volts. The batteries 14b as depicted in FIG. 13 may provide a total of 4.5 volts. As such, the regulator circuit 82b may be configured to reduce the amount of voltage provided to the LED 12b from the batteries 14b. As noted above, the regulator circuit 82b generally requires an input voltage of between one and eight volts. In the event the regulator circuit 82b receives 4.5 volts from the batteries 14b, the regulator circuit 82b may step down the voltage and transmit the desired voltage to drive the LED 12b to achieve the desired illumination. The regulator circuit 82b may measure the voltage across the resistor 84b and compare the measured voltage across the resistor 84b to the predetermined voltage value to ensure that the current delivered to the LED 12b is at the desired level.

As the voltage generating capabilities of the battery or batteries decrease over time, the regulator circuit may step up or boost the voltage provided to the LED. For example, in the event the plurality of batteries 14a of FIG. 12 provide a voltage of 3 volts or less to the regulator circuit 82a, the regulator circuit 82a may provide a voltage output that is higher than the 3 volts to power the LED 12a in the event such an increase in voltage is needed to achieve the desired illumination. In one example, the regulator circuit 82a that is capable of either boosting input voltage or decreasing input voltage may be the TPS61130, TPS61131, or TPS61132 buck/boost DC/DC converter circuit as produced by Texas Instruments®. It is generally contemplated that the regulator circuits as discussed in connection with the Figures may also be implemented as a buck/boost DC/DC converter. The timer 86b may operate in the same manner as described in connection with FIG. 11.

The battery or batteries are independent from the vehicle's electrical system and are generally lithium batteries. In one example, each battery may be implemented as a CR2450HR battery.

FIG. 14 is a diagram depicting an exemplary method 88 for regulating energy across the LED, such as LED 12 shown in FIGS. 2 and 3, of the vanity mirror light assembly. In operation 90, the LED is switched on, such as by opening a glove compartment door or a box-lid or by lifting a cargo floor. The LED illuminates because a switch is moved to a closed configuration, allowing a battery to power a regulator circuit. In operation 92, a timer begins counting in response to the switch closing. In operation 94, the regulator circuit can receive voltage from the battery (or plurality of batteries) and transmits an output voltage to the LED. The first time operation 94 is completed, the output voltage transmitted to the LED can be the voltage supplied by the battery. During subsequent completions of or “passes through” the operation 94, the output voltage transmitted to the LED can be different than the voltage supplied by the battery. For example, as will be set forth below, the output voltage transmitted to the LED by the regulator circuit can be greater than the voltage supplied by the battery.

In operation 96, the regulator circuit can measure the voltage drop across the resistor to assess whether the output voltage needs to be adjusted. In operation 98, the regulator circuit can compare the measured voltage drop across the resistor to the predetermined voltage value. If the measured voltage drop is less than the predetermined voltage value, then the method 88 continues to operation 100. If the measured voltage drop is greater than the predetermined voltage value, then the method 88 continues to operation 102.

In operation 100, the timer can determine whether the count sequence has expired. It is noted that the timer and the regulator circuit can be operating concurrently and generally independently. For example, a controller controlling both the timer and the regulator circuit is not required to practice the invention. Also, while the regulator circuit can carry out operation 94, the timer can carry out the operation 100. The timer and the regulator circuit are generally related as set forth below in the description of operation 104. The timer and the regulator circuit can otherwise be independent of one another. If the count sequence has expired at operation 100, then the method 88 continues to operation 104. If the count sequence has not expired, then the method 88 returns to operation 94. In the completion of operation 94 subsequent to operation 100 (a second or greater pass through operation 94), the regulator circuit can increase the amount of voltage delivered to the LED relative to the voltage provided by the battery.

In operation 102, the timer can determine whether the count sequence has expired. If the count sequence has expired, then the method 88 continues to operation 104 from operation 102. If the count sequence has not expired, then the method 88 returns to operation 94 from operation 102. In operation 94, the regulator circuit can decrease the amount of voltage provided by the battery in transmitting voltage to the LED. In operation 104, the timer can transmit the control signal to the regulator circuit so that the regulator circuit can discontinue providing voltage (or current) to the LED.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A combination comprising:
a compartment positioned in a vehicle and defined by a plurality of surfaces generally facing one another to define an interior volume such that said compartment is operable to hold a stowable item, wherein a first surface of said plurality of surfaces is substantially fixed relative to the vehicle and a second surface of said plurality of surfaces is movable relative to said first surface; and
at least one self-contained light mounted on said second surface and including at least one light emitting structure and at least one battery.

2. The combination of claim 1 wherein said at least one self-contained light further comprises:
a switch operable in a first configuration to selectively permit electrical current to pass to said at least one light emitting structure from said at least one battery and in a second configuration to prevent electrical current from passing to said at least one light emitting structure from said at least one battery, wherein said switch is further defined as operable to change between said first and second configurations in response movement of said second surface.

3. The combination of claim 2 wherein said switch moves with said second surface.

4. The combination of claim 2 wherein said switch is further defined as fully internal to said at least one self-contained light.

5. The combination of claim 2 wherein said switch is further defined as partially disposed internal of said at least one self-contained light and partially extending outside of said at least one self-contained light.

6. The combination of claim 2 wherein said at least one self-contained light further comprises:
a timer operable to change said switch from said first configuration to said second configuration after a predetermined period of time has passed.

7. The combination of claim 1 further comprising:
at least one aperture in said second surface; and
at least one projection extending from said self-contained light, said at least one projection deflectable during insertion into said at least one aperture.

8. The combination of claim 7 further comprising:
at least one removable cover defining part of said second surface before said at least one projection is inserted into said at least one aperture.

9. The combination of claim 8 wherein:
said at least one projection is further defined as a plurality of projections including a first set of projections extending from a lens of said self-contained light and a second set of projections extending from a housing member of said self-contained light, wherein said first set of projections are operable to engage said lens and said housing member together and said second set of projections are operable to engage said housing member and said second surface together;
said at least one aperture is further defined as a plurality of apertures differently sized from one another, including a first aperture operable to receive the first set of projections and a second aperture operable to receive the second set of projections; and
said at least one removable cover is further defined as a plurality of removable covers defining part of said second surface before either of said first and second sets of projections are inserted into either of said first and second apertures.

10. A combination comprising:
a plurality of compartments positioned in a vehicle, each defined by a plurality of surfaces generally facing one another to define an interior volume such that said compartment is operable to hold a stowable item, wherein a first surface of said plurality of surfaces is substantially fixed relative to the vehicle and a second surface of said plurality of surfaces is movable relative to said first surface; and
at least one self-contained light mounted on each of said second surfaces and including at least one light emitting diode and at least one battery.

11. The combination of claim 10 wherein each of said self-contained lights includes a mounting structure, wherein all of said mounting structures are substantially similar.

12. The combination of claim 10 wherein all of said self-contained lights are similarly shaped.

13. The combination of claim 10 wherein said plurality of compartments include a glove compartment and said second surface is defined on a door of said glove compartment.

14. The combination of claim 10 wherein said compartment is further defined as being positioned in a center console of the vehicle and said second surface is defined on a box-lid of said center console.

15. The combination of claim 10 wherein said compartment is further defined as being positioned in the trunk of the vehicle and said second surface is defined on a cargo floor disposed in said trunk.

16. The combination of claim 10 wherein each of said self-contained lights further comprises:
a switch operable in a first configuration to selectively permit electrical current to pass to said at least one light emitting diode from said at least one battery and in a second configuration to prevent electrical current from passing to said at least one light emitting diode from said at least one battery, wherein said switches operate independently of one another.

17. The combination of claim 16 wherein at least two of said self-contained lights further comprises:
a timer operable to change said switch from said first configuration to said second configuration after a predetermined period of time has passed.

18. The combination of claim 17 wherein less than all of said self-contained lights include said timer.

19. The combination of claim 10 wherein at least some of said self-contained lights include different mounting architecture.

20. A combination comprising:
a plurality of compartments positioned in a vehicle, each defined by a plurality of surfaces generally facing one another to define an interior volume such that said compartment is operable to hold a stowable item, wherein a first surface of said plurality of surfaces is substantially fixed relative to the vehicle and a second surface of said plurality of surfaces is movable relative to said first surface, including:
a first compartment being defined in an instrument panel with a second surface being an inwardly-facing surface on a door pivotally connected to said instrument panel,
a second compartment being defined in a center console with a second surface being an inwardly-facing surface on a box-lid pivotally connected to said center console, and
a third compartment being defined in a trunk with a second surface being the underside of a cargo floor; and
at least one self-contained light mounted on each of said second surfaces and including at least one light emitting diode and at least one battery, including:
a first light engaged with said second surface of said first compartment through a snap-fit connection,
a second light engaged with said second surface of said second compartment through a snap-fit connection, and
a third light engaged with said second surface of said third compartment through adhesive.
